(19) United States
(12) Patent Application Publication
(10) Pub. No.: US 2006/0093970 A1
(43) Pub. Date: May 4, 2006

(54) Combinations of preservatives and sequestrants to avoid formation of isonitrile malodor

(75) Inventors: Leif P. Olson, Rochester, NY (US); Shirleyanne E. Haye, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/980,366

(22) Filed: Nov. 3, 2004

(51) Int. Cl. G03C 5/00

(52) U.S. Cl. 430/331

(57) ABSTRACT

The present invention relates to a developer for photographic materials comprising at least one antioxidant and at least one polyvalent metal ion sequestrant, wherein the developer has reduced malodor.

### FIELD OF THE INVENTION

The present invention relates to a combination of antioxidant and sequestrant, which has reduced odor. The combination is useful in photographic developer compositions for use in the processing of silver halide photographic materials.

### BACKGROUND OF THE INVENTION

Color developers, such as, 4-amino-3-methyl-N-(.beta.-methanesulfonamidoethyl)aniline, are reducing agents, and are quite susceptible to aerial oxidation, that is, oxidation by dissolved oxygen. To alleviate this problem, developers generally contain an antioxidant, also referred to herein as a preservative, to preserve the oxidation state of the developer and maintain useful developer activity.

Many classes of compounds have been employed as developer solution antioxidants. Examples of suitable preservatives or antioxidants include sodium sulfite, potassium sulfite, sodium bisulfite, potassium bisulfite, sodium metabisulfite, potassium metabisulfite, carbonyl-sulfite adducts, hydroxylamines and hydroxylamine derivatives, hydroxamic acids, hydrazines, hydrazides, aminoketones, phenols, amino acids, mono- and polysaccharides, mono-, di-, and polyamines, ascorbic acid and derivatives thereof, alcohols, oximes, and nitroxy radicals.

The antioxidants must be soluble in aqueous media, have low toxicity to living organisms, be low in cost, and have little effect on the development of silver halide. Further, it is desirable that antioxidants react slowly with oxygen and rapidly with oxidized color developer, but not so rapidly that color development is retarded. Another factor to consider is that some antioxidants have been proven useful in photoprocessing for many years, and therefore their behavior is more predictable than new compounds that might lead to unexpected problems even if their odor properties are superior. These considerations greatly limit the number and class of compounds that can be used as practical antioxidants in color developer solutions.

The compounds most often employed as photographic color developer preservatives, or antioxidants, are the hydroxylamines. Hydroxylamines exhibit excellent characteristics as color developer antioxidants. Their rate of aerial oxidation is slow, they are not good silver halide developers, and they are relatively inexpensive to produce. Examples of hydroxylamines which have been used in color developers can be found in U.S. Pat. Nos. 4,978,786; 4,800,153; 4,801,516; 4,814,260; 4,965,176; 4,966,834; and 5,071,734.

Unfortunately, hydroxylamines, as a result of their preserving action, frequently react with other compounds in the development environment to yield volatile malodorous byproducts. One class of volatile malodorous byproducts that potentially arise from hydroxylamine decomposition is amines. In addition, the same types of hydroxylamines that tend to yield amine odors may also undergo an additional, particularly severe odor-causing reaction with certain polyvalent metal ion sequestering agents, particularly calcium ion sequestering agents commonly used in photographic developers, to yield the extremely malodorous class of compounds known as isonitriles, also known as isocyanides or carbylamines, for example, volatile isonitriles of structure R—N═C.

Calcium ion sequestering agents are generally considered as necessary components of photographic developer solutions. This is because water that is used in preparing photoprocessing solutions, for example water that is used to dilute concentrated developer solutions to “working strength”, may frequently contain metal ions, including calcium(II) ions. In the absence of said sequestering agents, the free calcium ions will tend to combine with the carbonate ion (used as the pH buffering agent) to precipitate as undesired deposits of calcium carbonate, for example within the developer tank of the photoprocessor. Such deposits may damage moving parts of the photoprocessing equipment, or may damage photographic materials that pass through the photoprocesing equipment, for example by scratching the photographic coatings.

While it is often possible to tolerate, cover up or control modest levels of amine odors, the odors arising from isonitriles are much more difficult to tolerate or control, even when formed in relatively much smaller amounts than amines. As an illustration of the potent odor of isonitriles, U.S. Pat. No. 3,197,493 discusses how traces of small alkyl isonitriles have been used to detect gas leaks, similar to the well-known use of volatile sulfur-containing organic compounds for this purpose. Also Temple, S., Hirsch, R. G., Journal of the Society of Cosmetic Chemists, 1977, 28, 765, find that methyl isonitrile is readily detectable as a malodor at concentrations of 10 to 20 parts per billion in air.

Considerable work has been carried out to improve various features of hydroxylamines, including their water-solubility so that odors from the release of volatile odorous byproducts are minimized. Hydroxylamines bearing various solubilizing groups, including hydroxyl, carboxyl and sulfonyl groups have been used to reduce the odor problem. While these solubilizing groups may add some desirable features to the hydroxylamine, they also usually add to the cost and molecular weight of the hydroxylamine.

### PROBLEM TO BE SOLVED

There is a need for combinations of hydroxylamine antioxidants and polyvalent metal ion sequestering agents for use in photographic developers that are low cost, photographically highly effective, and yet do not react to yield extremely malodorous isonitrile byproducts.

### SUMMARY OF THE INVENTION

The present invention relates to a developer for photographic materials comprising at least one antioxidant and at least one polyvalent metal ion sequestrant, wherein the developer has reduced malodor.

### ADVANTAGEOUS EFFECT OF THE INVENTION

The present invention includes several advantages, not all of which are incorporated in a single embodiment. The formation of isonitriles may be greatly reduced or eliminated with use of the combination of preservative and sequestrant of the present invention. The present invention, through reduction of offensive malodor, also allows use of some of the best or least expensive preservatives for developers.

### DETAILED DESCRIPTION OF THE INVENTION

The present invention relates to a developer for photographic materials comprising at least one antioxidant and at least one polyvalent metal ion sequestrant, wherein the developer has reduced malodor. Photographic developing compositions useful in the practice of this invention typically include one or more color developing agents and various other conventional addenda, including corrosion inhibitors and buffers. In a preferred embodiment of the present invention, the preservative compound carries a radical capable of forming a volatile isonitrile and the sequestrant does not bear a moiety of the form —X—CH₂—Y—. In the most preferred embodiment, the preservative is N,N-dialkylhydroxylamine R₁NH(OH)R₂ where both R₁ or R₂ are radicals capable of forming volatile isonitriles R₁—N═C and R₂—N═C, and the sequestrant bears a moiety of the form —N—CH(P)—P.

The developer of the present invention includes at least one polyvalent metal ion sequestrant. The sequestrant is specifically without a group that forms volatile malodorous isonitrile compounds in the presence of hydroxylamines. For example, sequestering agents that contain the —X—CH₂—Y moiety, where X and Y separately represent heteroatoms, i.e. neither X nor Y is a carbon atom, form volatile malodorous isonitrile compounds in the presence of certain hydroxylamines. In a preferred embodiment, the sequestrant lacks a moiety of Formula I:
—X—CH₂—Y Formula I
wherein X represents N, O, S, or P, and Y represents N, O, S, or P, with additional substitution possible for both X and Y. Mixtures of such compounds may be used if desired. Useful salts may include the ammonium and alkali metal ion salts.

One useful class of sequestrants includes hydroxyalkylidene diphosphonic acids, salts thereof. Especially useful sequestering agents contain the aminophosphonate functional group and salts thereof, e.g. of the general structure 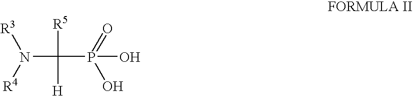
wherein R³ in particular may be considerably variable, e.g. R³=alkyl, substituted alkyl (commonly —CH₂PO₃H₂ and salts thereof, or —CH₂COOH and salts thereof), aryl or substituted aryl, or heterocyclic. R⁴ may be the same as R³, or as another possibility R⁴ and R³ may constitute a group of atoms forming a saturated or unsaturated ring. Most commonly, R⁴=—(CH₂CH₂N(CH₂PO₃H₂))ₙCH₂CH₂N(CH₂PO₃H₂)₂, where n=0, 1, or 2, or salts thereof; also known are mixed carboxylate and phosphonate sequestering agents, for example R⁴=—(CH₂CH₂N(CH₂COOH))ₙCH₂CH₂N(CH₂PO₃H₂)₂, where n=0, 1, or 2, or salts thereof; —(CH₂CH₂N(CH₂PO₃H₂))ₙCH₂CH₂N(CH₂COOH)₂, where n=0, 1, or 2, or salts thereof; or —(CH₂CH₂N(CH₂PO₃H₂))ₙCH₂CH₂N(CH₂PO₃H₂)(COOH), where n=0, 1, or 2, or salts thereof. Most commonly, R⁵═H, however other substitution is possible, e.g. R⁵=—PO₃H₂ (and salts thereof), COOH (and salts thereof), alkyl, substituted alkyl, aryl, or heterocyclic. Notably, many of these possibilities (for example, all cases where R⁵=H) include the moiety described in Formula I.

Representative sequestering agents containing phosphonate groups include, but are not limited to, 1-hydroxyethylidene-1,1-diphosphonic acid, available as DEQUEST® 2010 and the tetrasodium salt thereof, DEQUEST® 2016D available from Solutia Co., 1-hydroxy-n-propylidene-1,1-diphosphonic acid, 1-hydroxy-2,2-dimethylpropylidene-1,1-diphosphonic acid and alkali metal and ammonium salts thereof, and morpholinomethanediphosphonic acid or a salt thereof. A particularly useful sequestering agent of this type is diethylene-triaminepentamethylenephosphosphonic acid or an alkali metal salt thereof (available as DEQUEST® 2066 from Solutia Co.) and [nitrilotris(methylene)] phosphonic acid or salt thereof, (available as DEQUEST® 2006 from Solutia Co.). It is also possible to include other metal ion sequestering agents (for example, for iron, copper or manganese ion sequestration) in the color developing composition. A mixture of one or more diphosphonic acids may be used in the color developing composition of this invention if desired, in any desirable proportions.

The developer of the invention comprises at least one antioxidant As used herein, the terms “preservative” and “antioxidant” are used interchangeably and are understood by one skilled in the photographic finishing art as a compound or composition that inhibits the degradation of the color developer composition. Examples of suitable preservatives or antioxidants for use in the present invention include substituted and unsubstituted hydroxylamines, N,N-disubstituted hydroxylamines, and hydroxylamine derivatives, hydroxamic acids, mono-, di-, and polyamines, and oximes, provided that the preservative compound carries a radical capable of forming a volatile isonitrile.

In one embodiment, the preservative or antioxidant has the structure of Formula III:

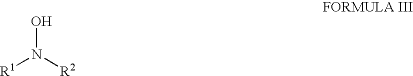

In the general formula (III), the alkyl and alkenyl groups represented by each of R¹ and R² may be linear, branched or cyclic or a combination thereof. The substituents R¹ and R² may contain halogen atoms (for example, F, Cl, Br), aryl groups (for example, phenyl, p-chlorophenyl), alkoxy groups (for example, methoxy, ethoxy, methoxyethoxy), aryloxy groups (for example, phenoxy), sulfonyl groups (for example, methanesulfonyl, p-toluenesulfonyl), sulfonamido groups (for example, methanesulfonamido, benzenesulfonamido), sulfamoyl groups (for example, diethylsulfamoyl, unsubstituted sulfamoyl), carbamoyl groups (for example, unsubstituted carbamoyl, diethylcarbamoyl), amido groups (for example, acetamido, benzamido), ureido groups (for example, methylureido, phenylureido), alkoxycarbonylamino groups (for example, methoxycarbonylamino), aryloxycarbonylamino groups (for example, phenoxycarbonylamino), alkoxycarbonyl groups (for example, methoxycarbonyl), aryloxycarbonyl groups (for example, phenoxycarbonyl), cyano group, hydroxyl group, carboxyl group, sulfo group, nitro group, amino groups (for example, unsubstituted amino, diethylamino), alkylthio groups (for example, methylthio), arylthio groups (for example, phenylthio), and heterocyclic groups (for example, morpholinyl, pyridyl).

The substituents in R¹ and R² may also be the same or different. R¹ and R² may preferably have carbon atoms of 1-10 with 1-5 being especially preferred. Illustrative examples of the nitrogen-containing heterocyclic ring, which is formed when R¹ and R² are joined together, may include piperidyl groups, pyrrolidinyl groups, N-alkylpiperazyl groups, morpholinyl groups, indolinyl groups and benztriazolyl groups.

Examples of suitable antioxidants are substituted or unsubstituted hydroxylamines, such as N-isopropyl-N-sulfonatoethylhydroxylamine, diethylhydroxylamine, such as N,N-diethylhydroxylamine, and salts thereof, such as the sulphate, chloride or phosphate salts. Hydroxylamines, in which R¹ and R² are both unsubstituted alkyl groups, are often most preferable due to low cost, despite their modest preserving ability and tendency to yield amine odor. An example of such a hydroxylamine is represented by the structure A-1. 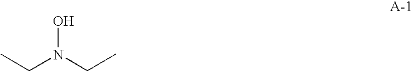
which can undergo chemical reactions with certain metal ion sequestering agents to yield ethyl isonitrile (CH₃CH₂—N═C), an extremely noxious-smelling compound. A-1 is a very inexpensive and useful antioxidant for photoprocessing.

Another useful antioxidant, N-isopropyl-N-sulfonatoethylhydroxylamine, represented by structure A-2: 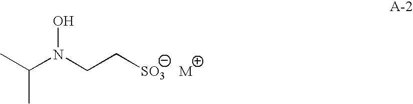
wherein M represents a hydrogen ion or metal ion, especially alkali metal ion, can undergo chemical reactions with certain metal ion sequestering agents to yield isopropyl isonitrile ((CH₃)₂CH—N═C), an extremely noxious-smelling compound. N-isopropyl-N-sulfonatoethylhydroxylamine (IPSHA)is an example of a photographically useful antioxidant that can be prepared using as one of the starting materials the readily available compound N-isopropylhydroxylamine, for example, N-isopropyl-N-carboxyethylhydroxylamine.

Typical examples of N,N-dialkylhydroxylamines include N,N-diethylhydroxylamine, N-ethyl-N-methylhydroxylamine, N-ethyl-N-propylhydroxylamine, N,N-dipropylhydroxylamine, N,N-dibutylhydroxylamine, and N-methyl-N-butylhydroxylamine, as described for example, in U.S. Pat. No. 4,892,804 (column 4, lines 35-51), incorporated herein by reference, a dialkylhydroxylamine of general formula (I) wherein R¹ and R² each represent an unsubstituted or substituted alkyl group or an unsubstituted or substituted alkenyl group or R¹ and R² may form a hetero ring together with nitrogen atom, as described in U.S. Pat. No. 4,876,174 (column 2, lines 2-13), incorporated herein by reference, compounds each represented by Formula (I) wherein R¹ and R² each represent a hydrogen atom or an alkyl or alkoxy group having 1 to 3 carbon atoms, provided that R¹ and R² are not hydrogen atoms at the same time, and R¹ and R² are allowed to couple to each other so as to complete a ring, as described in U.S. Pat. No. 5,354,646 (column 4, lines 30-40), incorporated herein by reference, hydroxylamine compounds represented by Formula III wherein R¹ or R² is independently a stabilizing group such that it has been found previously that when the hydroxylamine compound is added to a test developer solution, the pH of the test developer solution decreases less than 0.12 at an aeration time of 90 hours and R¹ or R² is a substituted or unsubstituted alkyl, aryl or heterocyclic group or combinations thereof and wherein R1 and R2 are directly bonded to N through a carbon atom, the alkyl group contains 1 to 20 carbon atoms, with 1 to 10 carbon atoms being most preferred, the aryl group contains 6 to 10 carbon atoms, the heterocyclic group may be a 5 to 15-membered ring containing one or two heteroatoms, preferrably nitrogen, sulfur and oxygen, the heterocyclic group is a 5 or 6-membered ring; for example, suitable aryl groups include phenyl, tolyl, naphthyl, and cycloheptatrienyl, suitable heterocyclic rings are pyrrole, furan, tetrahydrofuran, thiofuran, pyridine, picoline, piperidine, morpholine, pyrrolidine, thiophene, oxazole, thiazole, imidazole, triazole, tetrazole and oxadiazole. Preferably, R is a straight or branched alkyl group having 1 to 6 carbon atoms which may be substituted with a solubilizing group. Some examples of suitable groups are methyl, ethyl, isopropyl, t-butyl, —(CH₂)—COOR⁸, —CH₂ CH₂ OH, and —CH₂ COOR⁸ wherein R⁸ is H or an alkali or alkaline earth metal. R may also preferably be a substituted or unsubstitued phenyl group. Other substituents of R may include, for example, alkyl groups (for example, methyl, ethyl, hexyl), fluoroalkyl groups (for example, trifluoromethyl), aryl groups (for example, phenyl, naphthyl, tolyl), aryloxy groups (for example, phenoxy), sulfonyl groups (for example, methylsulfonyl, phenylsulfonyl), acylamino groups, sulfonylamino groups, acyloxy groups (for example, acetoxy, benzoxy), carboxy groups, cyano groups, sulfo groups, alkoxy groups (for example, methoxy, ethoxy, octyloxy), hydroxy groups, halogen atoms, alkylthio groups, arylthio groups, acyl groups and amino groups.

In addition to stabilizing the pH, the R¹ or R² groups must be soluble enough to effect dissolution in aqueous buffered alkaline solutions. They must also be compatible with a photographic developing composition and must have no unacceptably deleterious effects on the photographic processing system or the photographic element being processed.

R¹ and R² may contain any solubilizing group which reduces the vapor pressure of the hydroxylamine compound enough to render the compound free of significant unpleasant odor and which is not deleterious to the developing composition. Commonly used groups are —CH₂CH₂ OH, —CH₂CH₂SO₃ M, —CH₂CH₂PO₃ M or —COOM, and most preferably they are —COOM. M is —H or an organic or inorganic cationic group. Preferably M is —H an alkali metal ion. If M is an alkali metal ion, sodium or potassium are preferred.

The hydroxylamine compounds may be dissolved in an aqueous solution and then added to the developing composition or they may be added directly to the composition. The useful concentration of the compounds is about 0.005M to 0.1M, with 0.025M to 0.05M being preferred. The useful pH range of the developer is 9 to 13, with 9 to 11 being more preferred and 9.9 to 10.2 being most preferred.

Representative alkyl groups include, but are not limited to, methyl, ethyl, n-propyl, isopropyl, n-butyl, t-butyl, 2-methyl-1-propyl, n-pentyl, 2-ethyl-1-propyl, 2-methyl-3-methyl-1-pentyl, n-hexyl, n-octyl, n-decyl, n-dodecyl, benzyl, 2-cyclohexylethyl, and others readily apparent to one skilled in the art. Preferred alkyl groups are isopropyl, 2-methyl-1-propyl, 2-ethyl-1-propyl, 2-methyl-1-butyl and similar groups that are further substituted with groups other than alkyl groups (defined below). Most preferably, R is isopropyl.

Unless otherwise specifically stated, the groups defined above can be further substituted with one or more substituents which do not destroy properties essential for participation in the reaction of the present invention, or for their use in photographic processing solutions. Thus, when the term “group” is used in a definition, it means that one or more hydrogen atoms from a carbon, or nitrogen atom has been substituted with, for example, halo (chloro, bromo and the like), nitro, hydroxy, cyano, carboxy, sulfo, an alkenyl group, an alkynyl group, an amino group, an amido group, an alkoxy group, an aryl group, and aryloxy group, a carbonamido group, a sulfonamido group, a carbamoyl group, a sulfamoyl group, an acyl group, an imino group, phosphono (free acid or salt thereof), or a heterocyclic ring. Such groups would be readily apparent to one skilled in the art, and that person would also realize that any such substituents can be further substituted with the same or different substituents if desired.

The concentration of the preservative in the developer depends upon such factors as the particular preservative/antioxidant employed and the concentration of the color developer in the stabilized solution. Normally the concentration of the preservative will be in the range of from 1 to 40 weight percent, preferably from 1 to 30 weight percent, and more preferably from 2 to 15 weight percent, based on the total weight of the stabilized solution. Typical amounts are in the range from 0.25 to 5.5 g/l (as hydroxylamine sulphate).

Many of these antioxidants are mono- and dialkylhydroxylamines having one or more substituents on one or both alkyl groups. Structures of N-hydroxylamines of Formula I that can participate in formation of undesirable malodorous isonitrile products, such as isocyanide, when used in combination with compounds (e.g. calcium ion sequestrants) containing one or more —NCH₂P— moieties, may be defined with respect to the isocyanide compounds that can form, either R¹—NC or R²—NC, or both R¹—NC and R²—NC or, in some cases, R¹—NC═R²—NC. Many compounds containing an isocyanide functional group are well known to possess a malodor that is considered a characteristic of this functional group. If either of the isocyanides R¹—NC or R²—NC, or both R¹—NC and R²—NC, are malodorous, then the formulation containing the hydroxylamine and sequestrant containing the —N—CH₂—P— moiety can bear an isocyanide malodor.

The isocyanide malodor may appear immediately on mixing of the N-hydroxylamine and sequestrant, or may require longer periods such as days, weeks, or even months to appear. The time required for said malodor to appear depends on the nature of the formulation (for example, the pH and the concentrations of the individual components), as well as the temperature to which the formulation is subjected.

Compounds I-1 through 1-6 are examples of malodorous isocyanides (generally the molecular weight of the isocyanide must be <250 for it to be significantly malodorous. In some cases, functional groups that lower the volatility of the isocyanide will reduce or eliminate the malodor even if the molecular weight is below 250):
I-1: CH₃—NC
I-2: CH₃CH₂—NC
I-3: CH₃CH(CH₃)—NC
I-4: CH₃CH₂CH₂CH₂—NC
I-5: C₆H₅—NC
I-6: C₆H₅CH₂—NC

Examples of problem N-hydroxylamines R¹—N(OH)—R² that yield a malodor when combined with a calcium ion sequestrant containing the —NCH₂P— moiety, because either group R¹ or R² (or both), can yield a volatile malodorous isocyanide: 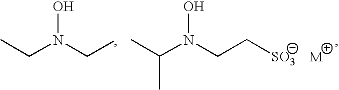
wherein M=hydrogen ion or metal ion, especially alkali metal ion, and

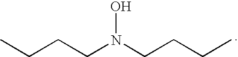

As used herein, “photographic processing composition” refers to a composition in liquid, solid or multi-phase form that is used in one or more photographic processing steps and that contains one or more “photochemicals” that participate, facilitate or otherwise foster a photochemical reaction or physical benefit in the photographic processing step. In most instances, the photochemicals are involved in some type of chemical reaction within the processed photographic material, or in the processing composition itself.

Photographic developing compositions useful in the practice of this invention typically include one or more color developing agents and various other conventional addenda in addition to the preservatives or antioxidants and metal ion sequestering agents. These materials can be present in conventional amounts. For example, the color developing agent is generally present in an amount of at least 0.001 mol/l (preferably at least 0.01 mol/l), and an antioxidant or preservative for the color developing agent is generally present in an amount of at least 0.0001 mol/l (preferably at least 0.001 mol/l). The pH of the composition is generally from 9 to 13, and preferably from 11.5 to 12.5.

Color developing compositions generally include one or more color developing agents that are well known in the art that, in oxidized form, will react with dye forming color couplers in the processed materials. Such color developing agents include, but are not limited to, aminophenols, p-phenylenediamines (especially N,N-dialkyl-p-phenylenediamines) and others which are well known in the art, such as described in U.S. Pat. No. 4,876,174 (Ishikawa et al.), U.S. Pat. No. 5,354,646 (Kobayashi et al.), U.S. Pat. No. 4,892,804 (Vincent et al.), and U.S. Pat. No. 5,660,974 (Marrese et al.), EP 0 434 097A1 (published Jun. 26, 1991), and EP 0 530 921A1 (published Mar. 10, 1993); Research Disclosure, publication 36544, pages 501-541 (September, 1994), and references cited therein. (Research Disclosure is a publication of Kenneth Mason Publications Ltd., Dudley House, 12 North Street, Emsworth, Hampshire PO10 7DQ England (also available from Emsworth Design Inc., 121 West 19th Street, New York, N.Y. 10011). This reference will be referred to hereinafter as “Research Disclosure”. Exemplary color developing compositions and components are also described in U.S. Pat. No. 5,037,725 (Cullinan et al.), U.S. Pat. No. 5,552,264 (Cullinan et al.), U.S. Pat. No. 5,508,155 (Marrese et al.), U.S. Pat. No. 4,482,626 (Twist et al.), U.S. Pat. No. 4,414,307 (Kapecki et al.), U.S. Pat. No. 4,264,716 (Vincent et al.), and U.S. Pat. No. 6,037,111 (Haye et al.), the disclosures of which are all incorporated herein by reference.

Preferred color developing agents include, but are not limited to, N,N-diethyl p-phenylenediamine sulfate (KODAK Color Developing Agent CD-2), 4-amino-3-methyl-N-(2-methane sulfonamidoethyl)aniline sulfate, 4-(N-ethyl-N-&bgr;-hydroxyethylamino)-2-methylaniline sulfate (KODAK Color Developing Agent CD-4), p-hydroxyethylethylaminoaniline sulfate, 4-(N-ethyl-N-2-methanesulfonylaminoethyl)-2-methylphenylenediamine sesquisulfate (KODAK Color Developing Agent CD-3), 4-(N-ethyl-N-2-methanesulfonylaminoethyl)-2-methylphenylenediamine sesquisulfate, and others readily apparent to one skilled in the art.

Buffering agents are generally present in the color developing compositions to provide or maintain desired alkaline pH of from 7 to 13, and preferably from 8 to 12. These buffering agents must be soluble in the organic solvent described herein and have a pKa of from 9 to 13. Such useful buffering agents include, but are not limited to carbonates, borates, tetraborates, glycine salts, triethanolamine, diethanolamine, phosphates and hydroxybenzoates. Alkali metal carbonates (such as sodium carbonate, sodium bicarbonate and potassium carbonate) are preferred. Mixtures of buffering agents can be used if desired.

In addition to buffering agents, pH can also be raised or lowered to a desired value using one or more acids or bases. It may be particularly desirable to raise the pH by adding a base, such as a hydroxide (for example sodium hydroxide or potassium hydroxide).

The composition can also include one or more of a variety of other addenda that are commonly used in photographic developing compositions, including alkali metal halides (such as potassium chloride, potassium bromide, sodium bromide and sodium iodide), auxiliary co-developing agents, black and white developing agents, antifoggants, development accelerators, wetting agents, fragrances, stain reducing agents, surfactants, defoaming agents, anti-sludging agents, bleaching agents, fixing agents, dye stabilizing agents, fixing accelerators, bleaching accelerators, formaldehyde precursors, fogging agents, crystal growth inhibitors and biocides, and water-soluble or water-dispersible color dye forming couplers, as would be readily understood by one skilled in the art [see for example, the Research Disclosure publications noted above]. The amounts of such additives would be well known to a skilled artisan.

The processing compositions of this invention can be provided in concentrated form and can be used directly, in diluted form, or used to prepare a replenishing solution. Concentrated compositions and methods of making are described for example in U.S. Pat. No. 5,948,604 (Craver et al.), incorporated herein by reference. Single-phase, single-part color developing compositions may be useful as described in U.S. Pat. No. 6,077,651 (Darmon et al.). Useful, multi-part color developing compositions are described in U.S. Pat. No. 6,136,518 (Buongiome et al.). Such concentrates can be diluted up to 10 times prior to or during use in the practice of this invention.

The color developing composition of this invention has obvious utility to a wide variety of types of photographic materials (both black-and-white and color negative and color reversal films and papers, and color motion picture films and prints) containing various types of emulsions can be processed using the present invention, the types of materials being well known in the art (see Research Disclosure publication 38957 noted above). The invention can be used to process color photographic papers of all types of emulsions including so-called “high chloride” and “low chloride” type emulsions, and so-called tabular grain emulsions as well. In particular, the invention can be used to process color photographic papers. The development composition can also be used in color reversal processing.

In a preferred embodiment the photographic material to be processed comprises a resin coated paper support and the emulsion layers comprise more than 80%, preferably more than 90% silver chloride and are more preferably composed of substantially pure silver chloride. The material may comprise the emulsions, sensitizers, couplers, supports, layers, additives, etc., described in Research Disclosure, December 1978, Item 17643, published by Kenneth Mason Publications Ltd., Dudley Annex, 12a North Street, Emsworth, Hants PO10 7DQ, UK.

The photographic materials can be single color materials or multicolor materials. Multicolor materials contain dye image forming units sensitive to each of the three primary regions of the spectrum. Each unit can be comprised of a single emulsion layer of multiple emulsion layers sensitive to a given region of the spectrum. The layers of the materials, including the layers of the image-forming units can be arranged in various orders as is known in the art.

A typical multicolor photographic material comprises a support bearing a yellow dye image-forming unit comprised of at least one blue sensitive silver halide emulsion layer having associated therewith at least one yellow dye-forming coupler, and magenta and cyan dye image-forming units comprising at least one green or red sensitive silver halide emulsion layer having associated therewith at least one magenta or cyan dye-forming coupler respectively. The material can contain additional layers, such as filter layers.

Representative commercial black-and-white films and papers that are useful in the practice of this invention include, but are not limited to, KODAK T-MAX 400 Film, KODAK TRI-X Pan Film, KODAK VERICHROME PAN Film, KODAK POLYMAX II RC Black and White Papers, KODAK KODABROME II RC F Black and White Paper, KODAK PMAX Art RC V Black and White Paper, KODAK POLYCONTRAST III RC Black and White Paper, KODAK PANALURE Select RC Black and White Paper, KODAK POLYMAX FINE ART Black and White Papers, KODAK AZO Black and White Papers, ILFORD MULTIGRADE IV RC and FB Black and White Papers, ILFORD ILFOBROME GALARIE Black and White Papers, and AGFA MULTICONTRAST CLASSIC and PREMIUM Black and White Papers.

Representative commercial color papers that are useful in the practice of this invention include, but are not limited to, KODAK EKTACOLOR EDGE V, VII and VIII Color Papers (Eastman Kodak Company), KODAK ROYAL VII Color Papers (Eastman Kodak Company), KODAK PORTRA III, IIIM Color Papers (Eastman Kodak Company), KODAK SUPRA III and 111M Color Papers (Eastman Kodak Company), KODAK ULTRA III Color Papers (Eastman Kodak Company), FUJI SUPER Color Papers (Fuji Photo Co., FA5, FA7 and FA9), FUJI CRYSTAL ARCHIVE and Type C Color Papers (Fuji Photo Co.), KONICA COLOR QA Color Papers (Konica, Type QA6E and QA7), and AGFA TYPE II and PRESTIGE Color Papers (AGFA). The compositions and constructions of such commercial color photographic materials would be readily determined by one skilled in the art.

KODAK DURATRANS, KODAK DURACLEAR, KODAK EKTAMAX and KODAK DURAFLEX photographic materials and KODAK Digital Paper Type 2976 can also be processed using the present invention.

Representative color negative films that can be processed using the delivery articles of this invention include, but are not limited to, KODAK ROYAL GOLD® films, KODAK GOLD® films, KODAK PRO GOLD® films, KODAK FUNTIME®, KODAK EKTAPRESS PLUS® films, EASTMAN EXR® films, KODAK ADVANTiX® films, FUJI SUPER G Plus films, FUJI SMARTFILM® products, FUJICOLOR NEXIA® films, KONICA VX films, KONICA SRG3200 film, 3M SCOTCH ATG films, and AGFA HDC and XRS films. Films suitable for processing according to this invention can also be those incorporated into what are known as “one time use cameras”.

Color negative films, which may also be processed with the method of the present invention, are films intended for scanning and electronic image processing rather than optical printing, as described for example in U.S. Pat. No. 6,021,277 (Sowinski et al) (column 8, line 50 to column 29, line 20), the disclosure of which is incorporated herein by reference.

The present invention can be used to process a color photographic silver halide material comprised of a blocked but releasable photochemical, such as a blocked but releasable color developing agent. Such a material is disclosed for example in U.S. Ser. No. 09/475,510 filed Dec. 30, 1999 by Irving et al (column 4, line 29 to column 59, line 43), the disclosure of which is incorporated herein by reference. The photochemical(s) provided by lamination of the photochemical delivery article to a photographic material containing such a releasable, photographically useful chemical can be an chemical acid or a base that releases the blocked photochemical.

Other materials useful in the practice of this invention are color negative films that have specific dye forming coupler concentrations in each color recording unit (for example, at least 400 mg/m 2), or that include one or more “bleach accelerating releasing couplers” (BARC's) in such recording units at a coverage of at least 20 mg/m 2.

Alternatively, if the color negative films are to be scanned prior to fixing, it is desirable to omit color masking couplers or dyes, filter dyes and antihalation dyes in order to reduce scanning induced noise. Such films may also contain less silver than most color negative films, that is less than 3.5 g/m 2, and preferably from 1.5 to 3 g/m 2.

The present invention can also be used to provide positive color images in color reversal photographic films. The typical sequence of steps includes first development (black-and-white development), reversal processing step, color developing, bleaching, fixing, and stabilizing. There may be various washing steps between other steps, as well as a pre-bleach step or conditioning step before bleaching. Alternatively, dye stabilizing can occur between color developing and bleaching. Many details of such processes are provided in U.S. Pat. No. 5,552,264 (column 3 line 10 to column 7, line 62), incorporated herein by reference. Other details are provided in Research Disclosure, publication 38957 (noted above), and references noted therein. Useful reversal compositions are described, for example, in U.S. Pat. No. 3,617,282 (Bard et al), U.S. Pat. No. 5,736,302 (Buongiorne et al) and U.S. Pat. No. 5,811,225 (McGuckin et al).

Processing of an imagewise exposed photographic silver halide element is carried out by contacting the element with a developing composition under suitable time and temperature conditions, in suitable processing equipment, to produce the desired developed image. Additional processing steps can then be carried out using a bleach-fixing composition replenished by the bleach-fixing precursor compositions described herein. Bleach-fixing and additional processing steps can be carried out using conventional times and temperatures. Various rinsing and/or stabilizing and drying steps can also be used as would be known in the art. Useful processing steps, conditions and materials useful therefor are well known for the various processing protocols including the conventional Process C-41 processing of color negative films, Process RA-4 for processing color papers and Process E-6 for processing color reversal films (see for example, Research Disclosure, noted above).

Developing compositions are generally used prior to “desilvering” using the bleach-fixing precursor compositions described herein. Development is carried out by contacting the element under suitable time and temperature conditions, in suitable processing equipment, to produce the desired developed image. Additional processing steps can then be carried out using conventional procedures, including but not limited to, steps of stopping development, bleaching, fixing (or bleach/fixing), washing (or rinsing), stabilizing and drying, in any particular desired order. Useful processing steps, conditions, and materials are well known (see for example, Research Disclosure, noted above).

To obtain positive color images in color reversal photographic films, the typical sequence of steps includes first development (black-and-white development), a reversal (or universal fogging) step, developing, prebleaching or conditioning, bleaching, fixing, and stabilizing and/or rinsing. After the first development step, the processed color reversal materials are subjected to a reversal composition such as those described, for example, in U.S. Pat. No. 3,617,282 (Bard et al), U.S. Pat. No. 5,736,302 (Buongiorne et al), U.S. Pat. No. 5,811,225 (McGuckin et al), U.S. Pat. No. 6,033,833 (Tsoi et al.), U.S. Pat. No. 6,074,805 (Badger et al.), incorporated herein by reference. Alternatively, the materials can be subjected to universal fogging using known techniques to render all previously unexposed silver halide developable to silver metal.

There may be various water washing steps between other steps. Alternatively, dye stabilizing can occur in the prebleaching or conditioning step between developing, preferably color developing, and bleaching. Many details of such processes are provided in U.S. Pat. No. 5,552,264 (column 3 line 10 to column 7, line 62), incorporated herein by reference. Other details are provided in Research Disclosure, publication 38957 (noted above), and references noted therein.

Processing can be carried out using any suitable processing equipment, including deep tank processors, and “low volume thin tank” processes including rack and tank and automatic tray designs, as described for example in U.S. Pat. No. 5,436,118 (Carli et al.), and publications noted therein. Thus, processing can be carried out in large-scale processing labs, or in what are known as “mini-labs” that are normally placed in smaller environments. Rotary tube processors can also be used for processing photographic materials.

The prebleaching or conditioning composition can be provided as one component of a processing kit that includes one or more other processing compositions necessary for providing positive color images (for example, black-and-white developing compositions, reversal compositions, developing compositions, bleaching compositions, fixing compositions, bleach-fixing compositions, and stabilizing and/or rinsing compositions), as well as optional chemical components, metering devices, instructions and other addenda common to processing kits. These kits can be provided in a single package of suitable design with each processing composition in a suitable container in the form of glass or plastic bottles, vials, syringes, packettes, barrels, partially or wholly collapsible containers (as described for example in U.S. Pat. No. 5,577,614 of Palmeroni, Jr. et al.). While it is preferable that all of the compositions be in aqueous form, some or all of them can be in solid form as tablets, pellets, powders, or granules. One way of packaging processing compositions into a processing kit is described in U.S. Pat. No. 5,948,604 (noted above).

Such low volume thin tank systems are described in more detail in the following patent specifications: U.S. Pat. No. 5,294,956; U.S. Pat. No. 5,179,404; U.S. Pat. No. 5,270,762; EP-A-559,025; EP-A-559,026; EP-A-559,027; WO 92/10790; WO 92/17819; WO 93/04404; WO 92/17370; WO 91/19226; WO 91/12567; WO 9207302; WO 93/00612, WO 92/07301 and U.S. Pat. No. 5,436,118.

The following examples are provided to illustrate the invention.

### EXAMPLES

### Example 1

The compound ethyl isonitrile (CH3CH2N═C) was identified by GC/MS as a potential odor contributor in photoprocess chemicals containing preservative compounds carrying a radical capable of forming a volatile isonitrile and a sequestrant, which does not bear a moiety of the form —X—CH₂—Y—. An authentic sample of ethyl isonitrile for odor and GC/MS comparisons was prepared using the following method (adapted from Weber, W. P.; Gokel, G. W., Tetrahedron Letters 1972, 1637):

Ethylamine (44 mmol; 3.5 mL of a 70% solution in H₂O) was mixed with chloroform (44 mmol; 3.5 mL), methylene chloride (13 mL), and a solution of sodium hydroxide (133 mmol, 5.3 g) that had been previously dissolved in 5 mL of water. A phase transfer catalyst (0.11 g of triethylbenzylammonium chloride) was added to the two-phase mixture, and rapid magnetic stirring was commenced at room temperature. After approximately 30 minutes of reaction, the organic portion of the reaction mixture was separated. This yielded a mixture of the isonitrile in methylene chloride, confirmed subsequently using GC/MS. This reaction mixture had an extremely unpleasant odor.

Isopropyl isonitrile was prepared by a similar method, except that 44 mmol of isopropylamine was used in place of ethylamine. Formation of isopropyl isonitrile was then confirmed by GC/MS. This reaction mixture had an extremely unpleasant odor, similar to ethyl isonitrile.

To evaluate the requirements for an isonitrile odor to form, Odor Test Solutions with composition that are similar to some concentrated photographic developer replenisher solutions were prepared. Samples were prepared on a 10-mL scale in 20-ml glass vials. The vials were capped and placed in an oven at 55° C. for a period of 14 days, to accelerate the odor-generating process. Samples were evaluated for odor after 5 days, and again at 14 days if no odor had appeared after 5 days.

Odor Test Solutions:

4.5 g of diethylene glycol
3.5 g of 47% aqueous potassium carbonate
1.16 g of substituted hydroxylamine (if present)
0.4 g of calcium ion sequestering agent (if present)

Water to 10.0 mL

TABLE 1
Results for Odor Test Solutions containing variations of substituted
hydroxylamines and calcium ion sequestering agents, after 14 days of
accelerated aging at 55° C.

| Test | Hydroxylamine | Sequestrant | Odor | Type | Comment |
|---|---|---|---|---|---|
| 1 | DEHA | Dequest ® 2066 | severe | isonitrile | Confirmed |
| | | | | | by |
| | | | | | GC/MS |
| 2 | DEHA | Nitrilo-tris | severe | isonitrile | |
| | | (methylenephosphonic | | | |
| | | acid, | | | |
| | | trisodium salt | | | |
| | | (Dequest 2006) | | | |
| 3 | DEHA | None | mild | amine | |
| 4 | DEHA | Budex ® 5103 | mild | amine | |
| (invention) | | (morpholino | | | |
| | | methanediphosphonic | | | |
| | | acid, | | | |
| | | disodium salt | | | |
| 5 | DEHA | diethylene | mild | amine | |
| | | triamine | | | |
| | | pentaacetic acid | | | |
| 6 | None | Dequest ® 2066 | None | | |
| 7 | IPSHA | Dequest ® 2066 | severe | isonitrile | Confirmed |
| | | | | | by |
| | | | | | GC/MS |
| 8 | IPSHA | Budex ® 5103 | slight | amine | |
| (invention) | | | | | |
| 9 | IPSHA | None | slight | amine | |
| 10 | N,N-bis(2- | Dequest ® 2066 | None | | |
| | sulfonatoethyl)hydroxylamine, | | | | |
| | disodium salt | | | | |
| 11 | N,N-bis(2,3- | Dequest ® 2066 | None | | |
| | propane diol) | | | | |

These results show that the formation of the offensive isonitrile odor requires both the presence of a compound bearing X—CH2-Y moiety (where X and Y both represent heteroatoms, e.g. N—CH2-P) and a hydroxylamine R1N(OH)R2, where either R1 or R2, or both, can form part of a volatile isonitrile R1-N═C or R2-N═C. The invention examples contain hydroxylamines R1N(OH)R2, where either R1 or R2, or both, can form part of a volatile isonitrile R1-N═C or R2-N═C, however there is no compound bearing the X—CH2-Y moiety (where X and Y both represent heteroatoms).

### Example 2

Color Paper Color Developing Concentrate and Processing Concentrates were prepared, similar to those described in Example 1 of Darmon et al., U.S. Pat. No. 6,228,567. First we describe a preparation of the full concentrate (about 100 mL), formulated in the following manner:

A solution of sodium hydroxide (50% solution, 7.4 g) was added to a solution of 4-(N-ethyl-N-2-methanesulfonylaminoethyl)-2-methylphenylenediamine sesquisulfate (KODAK color developing agent CD-3, 12.6 g) and A-1 (5.4 g) in water (10 g). Because diethylhydroxylamine is an organic liquid, two phases resulted. With stirring, diethylene glycol (40 g) was then added, and a precipitate of sodium sulfate was observed. This precipitate was filtered out of the solution. Thus, the concentrate was essentially free of sulfate ions. The following components were then added to the concentrate:

| | |
|---|---|
| Triethanolamine (85% solution) | 4.6 g |
| Substituted triazinylstilbene optical brightener | 1.7 g |
| 1-Hydroxyethylidene-1,1-diphosphonic acid (60% w/w | 0.11 g |
| solution, DEQUEST ™ 2010) | |
| DEQUEST ™ 2066 diethylenetriaminepenta- | 8 g |
| phosphonic acid, sodium salt (Solutia Co.) | |
| Potassium bromide | 0.04 g |
| Potassium carbonate (47% solution) | 63.6 g |
| Fragrance | 0.2 g |

After addition of these components, the mixture was stirred until a homogeneous solution was obtained.

Additional partial solutions were prepared, each lacking a single component of the complete Color Paper Color Developing Concentrate. Portions (5 mL) of each solution were then placed in separate 40-mL glass septum-capped vials. The vials were placed in an oven at 55° C. for a period of 14 days. After this time, the vapors above each sample were evaluated by GC/MS to test for the presence of volatile isonitrile products, e.g. ethyl isonitrile. The samples were also human-evaluated for isonitrile odor. Results are in Table II.

TABLE II

| SAMPLE | MISSING | | ODOR OF |
|---|---|---|---|
| ID | COMPONENT | GC/MS RESULT | ISONITRILE |
| 1 | None | Ethyl isonitrile | YES |
| | | detected | |
| 2 | DEHA | No Ethyl isonitrile | NO |
| | | detected | |
| 3 | Frangrance | Ethyl isonitrile | YES |
| | | detected | |
| 4 | DEQUEST ™ 2010 | Ethyl isonitrile | YES |
| | | detected | |
| 5 | DEQUEST ™ 2066 | No Ethyl isonitrile | NO |
| | | detected | |
| 6 | Potassium bromide | Ethyl isonitrile | YES |
| | | detected | |
| 7 | Substituted | Ethyl isonitrile | YES |
| | triazinylstilbene | detected | |
| | optical brightener | | |
| 8 | KODAK CD-3 color | Ethyl isonitrile | YES |
| | developing agent | detected | |
| 9 | Triethanolamine | Ethyl isonitrile | YES |
| | | detected | |

These results show that the formation of the isonitrile odor in this concentrate requires the simultaneous presence of a compound bearing a X—CH2Y moiety (where X and Y both represent heteroatoms) and a hydroxylamine R1N(OH)R2 where either R1 or R2, or both, can form part of a volatile isonitrile R1-N═C or R2-N═C. Specifically, DEQUEST™ 2066 bears the N—CH2-P moiety and the substituents on DEHA (R1=R2=ethyl) can form part of the volatile isonitrile CH3CH2—N═C.

### Example 3

Solutions were prepared similar to the complete Color Paper Color Developing Concentrate of Example 2, except using either diethylenetriaminepentaacetic acid (DTPA) or BUDEX™ 5103 (morpholinomethanediphosphonic acid, “MMDP”) in place of DEQUEST™ 2066. After 14 days of aging similar to Examples 1 and 2, the odor of the samples was evaluated and it was determined that there was no isonitrile odor.

These results show that selected calcium ion sequestering agents lacking the X—CH2-Y moiety, where X and Y both represent heteroatoms, do not induce the isonitrile odor.

### Example 4

Solutions were prepared similar to the complete Color Paper Color Developing Concentrate of Example 2, except using either diethylenetriaminepentaacetic acid (DTPA) or BUDEX™ 5103 (morpholinomethanediphosphonic acid, “MMDP”) in place of DEQUES™ 2066 and DEQUEST™ 2010. After 14 days of aging similar to Examples 1 and 2, the odor of the samples was evaluated and it was determined that there was no isonitrile odor.

Comparison to similar samples in Example 3 indicated no difference caused by the presence or absence of DEQUEST™ 2010, which lacks an X—CH2-Y moiety. This is consistent also with the results from Example 2, which likewise showed that the presence or absence of DEQUEST™ 2010 had no effect on the isonitrile odor.

The invention has been described in detail with particular reference to certain preferred embodiments thereof, but it will be understood that variations and modifications can be effected within the spirit and scope of the invention.

1. A developer for photographic materials comprising at least one antioxidant and at least one polyvalent metal ion sequestrant, wherein said developer has reduced malodor.

2. The developer of claim 1 wherein said preservative comprises at least one hydroxylamine group or derivative thereof.

3. The developer of claim 2 wherein said preservative comprises the following formula 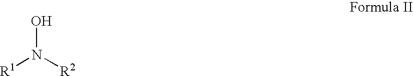
wherein at least one of R¹ and R² independently represent a radical capable of forming a volatile isonitrile.

4. The developer of claim 3 wherein at least one of R1 and R2-N═C and/or R2-N═C

5. The developer of claim 1 wherein said preservative comprises a member selected from the group consisting of N,N-diethylhydroxylamine, N-isopropyl-N-sulfonatoethylhydroxylamine, N,N-dibutylhydroxylamine or N-isopropyl-N-carboxyethylhydroxylamine.

6. The developer of claim 1 wherein said polyvalent metal ion sequestrant comprises a compound without a group which forms a volatile compound in the presence of hydroxylamines.

7. The developer of claim 6 wherein said polyvalent metal ion sequestrant which does not contain a moiety of the form —X—CH2-P—.

8. The developer of claim 7 wherein X comprises N, O, S, or P.

9. The developer of claim 6 wherein said polyvalent metal ion sequestrant comprises aminophosphonate.

10. The developer of claim 6 wherein said polyvalent metal ion sequestrant comprises diethylenetriaminepentamethylenephosphonic acid and salts thereof and nitrilo(tris)methylenephosphonic acid and salts thereof.

11. The developer of claim 1 wherein said photographic materials comprises color paper.

12. The developer of claim 1 wherein said developer comprises a concentrate.

13. The developer of claim 12 wherein said concentrate comprises a single part replenisher

14. The developer of claim 1 wherein said developer comprises di-sub

15. The developer of claim 1 wherein said developer comprises a pH from 8 to 13.

16. The developer of claim 1 wherein said malodor is derived from volatile isonitrile.
